(19) United States
(12) Patent Application Publication
(10) Pub. No.: US 2002/0099919 A1
(43) Pub. Date: Jul. 25, 2002

(54) Method of memory management

(75) Inventors: Eric Normant, Montigny Le Bretonneux (FR); Damien Jugie, Paris (FR); Benoit Guillon, St Amand Longpre (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THALES, PARIS (FR)

(21) Appl. No.: 10/020,459

(22) Filed: Dec. 18, 2001

(30) Foreign Application Priority Data
Dec. 19, 2000 (FR) 00 16585

(51) Int. Cl. G06F 12/00

(52) U.S. Cl. 711/170

(57) ABSTRACT

In a method for the management of the memory of a processing machine comprising several elementary computers each having a local memory, an initial quantity of memory is allocated in each computer; then a dynamic allocation and a dynamic release of objects are carried out such that the first released object is the last allocated object; an attachment/detachment of at least one remote computer is made with respect to a declared object shared by the computer that is the proprietor of the object, with a list of attachments managed by the elementary computer that is the proprietor of the shared object; a transfer is made from an object of a computer to a shared object of a remote computer; and a release of the local memory is made for each computer. A memory manager is an opaque object providing services through which the management method carries out requests to make dynamic allocations on the one hand and attachments to remote memories on the other hand. The memory management tools delivered with the machine are replaced by a memory management library implementing the method. Application to the development of radar modes.

### BACKGROUND OF THE INVENTION

1. Field of the Invention

The method and device of the invention relate to the management of the memory of a digital processing machine comprising several elementary computers. They mask the particular features of the memory of the processing machine from the software developer, and provide him with memory management means more elaborate than the specific tools delivered with the memory. They can be used in real-time applications, especially in the field of radars. They can also be applied to developer's workshops.

2. Description of the Prior Art

Processing machines have various physical architectures but, in general, a processing machine consists of a plurality of elementary computers, an elementary computer representing the association of a Computation resource known as a “processor”, a RAM or random-access memory and a input/output function of communication with the exterior, this function taking the form, for example, of a memory device or any other elementary computer.

Digital processing machines dedicated to reel-time signal processing applications, known COTS or [symbol] Commercial Off-The-Shelf [symbol] devices are commercially distributed along with their basic associated software, especially the operating system, the compiler, the debugger and the optimized mathematical libraries. These machines which are developed for a wide range of customers and applications are less costly than machines whose architecture and software are specific to a field such as, for example, the field of airborne radar.

The basic software delivered with the COTS processing machine provides the developer with a software application of the tools to manage dynamic memory allocations and dynamic memory releases during the execution of the application. However, these tools prove to be insufficient before the possibility of errors such as oversight in the releasing of a memory zone after use or the use of a non-allocated zone. Such errors could give rise to sudden stoppages, the erasure of very valuable data or even the erasure of the program itself. The defects of a software application due to these errors, poorly managed by the basic software, are very costly at the time of development of the software application because it is difficult to ensure that they are eliminated and, above all, to ensure that they are detected

Furthermore, a repeated use of dynamic memory allocations and dynamic memory releases may induce substantial fragmentation of the memory. This means that it is no longer possible to have the entire free memory available contiguously, and leads to a loss of efficiency of the application because of the associated system calls.

To overcome these drawbacks, the invention proposes to replace the memory management tools delivered with the machine by a memory management library implementing a particular method of management.

### SUMMARY OF THE INVENTION

According to the invention, the method for the management of the memory of a processing machine comprising several elementary computers each having a local memory, comprises the following services:

an allocation of an initial quantity of memory in the local memory of at least one elementary computer;

a dynamic allocation and a dynamic release of objects by the elementary computer in its initial quantity of memory, such that the first released object is the last allocated object;

a dynamic allocation, by an elementary computer in its initial quantity of memory, of a shared object such that said elementary computer is the proprietor of the shared object and declares this shared object to be accessible to one or more remote elementary computers;

an attachment of at least one remote elementary computer to the shared object, said remote elementary computer not being a proprietor of the shared object, with a list of attachments managed by the elementary computer that is the proprietor of the shared objects;

a detachment of a remote elementary computer from the shared object with the updating of said list of attachments;

the transfer from an object of an elementary computer to a shared object of a remote elementary computer;

a release of the local memory for each elementary computer.

According to the invention, the method comprises a memory manager through which the method carries out said services. A memory manager is created for each elementary computer on which the method carries out an allocation of an initial quantity of memory in the local memory. The memory manager of a computer is instantiated during this allocation.

The invention also relates to a processing machine used to implement the management method.

The invention can be applied to languages such as C-ANSI, C++ and ADA.

The invention uses a memory management entity through which the application can know the state of the local memory of each elementary computer at each point in time. The memory manager is an opaque object offering services through which the management method carries out requests to make, firstly, dynamic allocations and, secondly, attachments to remote memories. A quantity of local memory is allocated only once during the instantiation of the memory management entity. Then, the memory objects are dynamically instantiated in this initial quantity of memory. The allocations and releases of memory objects are done in a specified order so that the first object released corresponds to the last object allocated. A memory object allocated in shared mode by its proprietor computer can be accessed by a remote computer. Access to a remote memory is obtained by access to the remote manager. An attachment to an object by a remote computer is stored in a zone reserved for this remote computer within the memory of the proprietor computer of the object. An object is destroyed only by its proprietor computer and the shared object is destroyed only when there is no attachment. The invention prevents the fragmentation of the memory and controls memory destruction.

The invention proposes a memory transfer in order to read or write a remote object in shared mode while restricting the period of use of limited resources of the processing machines such as, for example, resources needed for the mapping of the remote memory manager. The invention can be used to carry out parallel memory transfers to several remote elementary computers.

The invention reinforces the verification made on the use of the memory. It eliminates the defects due to poor memory management which are possible and may be frequent when the memory is directly exploited by means of the basic tools delivered with COTS real-time processing machines.

With the invention, the software application developer does not have to be concerned about the particular features of the memory of the processing machine. The development effort is lightened by the removal of any need for fine memory management, and development costs are reduced.

It contributes to the portability of the application on a wide variety of machines, especially development machines and several versions of a target machine by encapsulating the memory management part. The invention can be implemented in a development workshop on a general machine and then on a target machine by cross compilation.

### BRIEF DESCRIPTION OF THE DRAWINGS

Other features and advantages of the invention shall appear from the following description made with reference to be appended drawings, of which:

FIG. 1 exemplifies a processing machine;

FIG. 2 exemplifies a memory manager according to the invention;

FIG. 3 exemplifies the conversion of a remote address into a local address;

FIG. 4 shows a data transfer between a local object and a remote object;

FIG. 5 shows a transfer of data among memory descriptors.

### MORE DETAILED DESCRIPTION

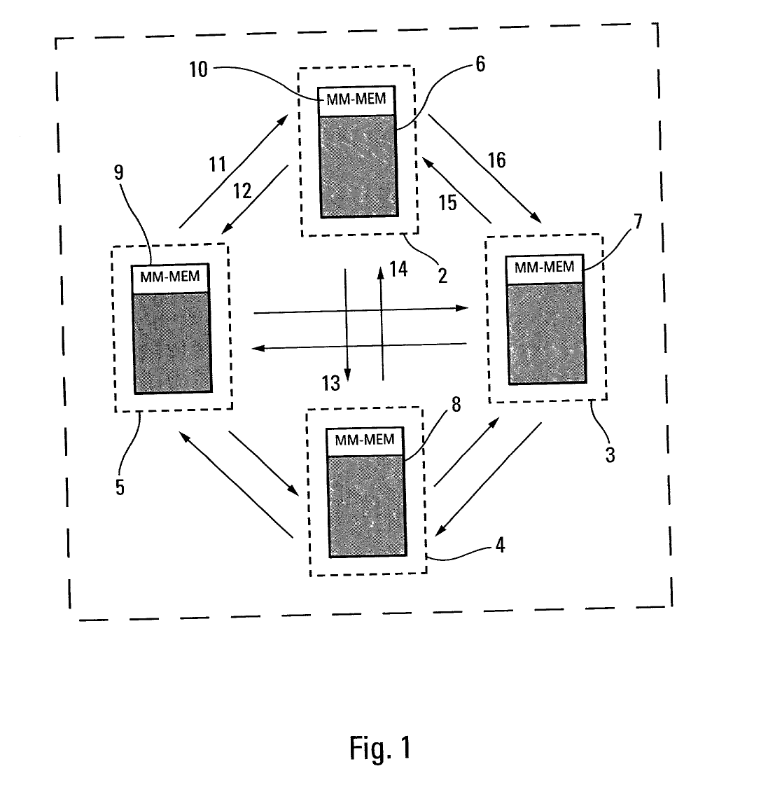

FIG. 1 illustrates a processing machine 1 comprising a plurality of elementary computers, for example four elementary computers 2 to 5, each comprising a local memory 6 to 9. When the management of the memory is initialized, the method carries out a dynamic allocation of an initial quantity of the local memory 6 of an elementary computer 2. This quantity preferably corresponds to the totality of the local memory available. The allocation is done by a call to the operating system of the machine, for example in the programming language C by means of a MALLOC( ) call. An object known as a memory manager 10 is attached to this allocated local memory, for example at the head of this memory. The memory management method then uses the initial quantity of local memory by means of the services of the manager object.

When the memory management is initialized, the method furthermore set up access points 11 and 12,13 and 14,15 16 between the memory of an elementary computer 2 and the memory of each of the other elementary computers 3 to 5 of the machine. This access provides for visibility between elementary computers.

The method carries out the initialization of the memory and of the access for each of the elementary computers participating in the application. Preferably, the allocation of local memory is carried out on each of the elementary computers with a management object having the same structure.

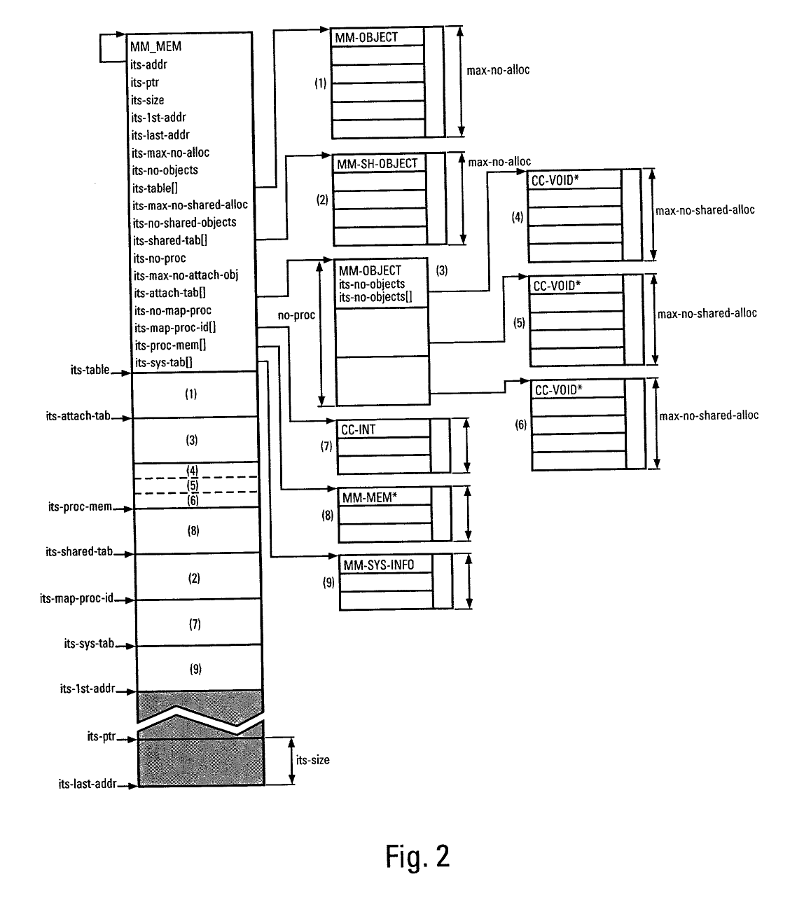

An exemplary internal structure of the memory management entity is illustrated in FIG. 2. The structural descriptor MM_MEM comprises the following fields:

the address of the memory manager in the local memory, its_addr;

the address of the free memory zone, its_ptr;

the memory size available, its_size;

the start of the available memory zone, its_{—}1st_addr

the end of the available memory zone, its_last_addr;

the maximum number of allocatable objects, its_max_no_alloc;

the current number of allocated objects, its_no_objects;

the table 1 of MM_OBJECT type allocated objects, its_table;

the maximum number of shared objects, its_max_no_shared_alloc;

the current number of shared objects, its_no_shared_objects;

the table 2 of MM_SH_OBJECT type shared objects, its_shared_tab

the number of declared elementary computers, its_no_proc

the maximum number of attachable objects, its_max_no_attach_obj;

the table 3 per computer of the MM_ATTACH type attached objects, its_attach_tab;

the number of mapped computers, its_no_map_proc;

the table 7 of the logic numbers associated with the mapped computers, its_map_proc_id;

the table 8 of the addresses of the computer manager objects, its_proc_mem;

the table 9 of the MM_SYS_INFO type information, specific to the machine for the computers, its_sys_tab;

The memory manager object of a computer especially has MM_OBJECT type objects which are allocatable memory objects in the initially allocated quantity of local memory and MM_SH_OBJECT type objects that enable a memory object, called a shared object, to be accessible to all the other computers.

The size of the tables of the memory manager depends on the characteristics of the machine considered and on the parameters of instantiation of the method such as the maximum number of authorized object allocations and the maximum number of objects allocatable in shared mode.

In the example of FIG. 2, the machine has three declared elementary computers for the application, its_no_proc equals 3, with a maximum of 6 allocatable objects, its_max_no_alloc equals 6, of which a maximum of 5 may be declared to be shared, its_max_no_shared_alloc equals 5.

The management method comprises a service MM_init( ) for the instantiation of the memory manager. This service relies on the basic system management software of the machine and carries out the following operations. The service identifies the elementary computers of the machine, for example by means of the number of the first and last elementary computer. Then it retrieves the size of the available memory of the current elementary computer and aligns its value on a word boundary, for example that of an eight-byte word known as a long word. This service determines the sizes of the different entities of the descriptor MM_MEM and aligns their values on a word boundary. It calculates the sum of the sizes of the entities contained in the memory manager structure, which corresponds to the total size of the structure, and the service checks that this size does not exceed the size of the available memory. Then, the service preferably allocates the entire available memory of the current elementary computer by making a call to the management of the machine operating system, and it checks the success of the allocation. It attaches the memory entity to the memory zone thus allocated. The instantiation service then carries out an initialization of the memory entity by initializing the pointers of the descriptors as a function of the different sizes, an initialization of the system structures in the table its_sys_tab of the MM_SYS_INFO type information specific to each elementary computer by making a call to the management of the machine operating system, an initialization of the fields of the descriptor, and an initialization of future mapping operations on the remote elementary computers.

The service carries out an operation for making the memory descriptor visible to the remote computers by making a call to the management of the machine operating system. For each elementary computer distinct from the current computer, called a remote computer, the service makes an attachment of the current computer to the memory of the remote computer by a call to the management of the machine operating system. The service MM_init( ) for the instantiation of the memory manager sends back a pointer to the initialized memory descriptor.

Once the manager has been instantiated, the method consists of a dynamic allocation and dynamic release of memory in the initially allocated quantity of memory. This is done by means of two dedicated services MM_alloc( ) and MM_free( ).

Through the service MM_init( ), the memory management method uses the operating system of the processing machine to carry out only one allocation of the local memory of the elementary computer at the instantiation of the memory management entity. The entire available memory is allocated only once and all the entities instantiated thereafter are instantiated on the basis of this initial quantity of memory. The method limits the number of calls on the operating system of the processing machine. The method has the advantage of reducing the processing time.

The dynamic memory allocation service MM_alloc( ) is used to allocate a new object in the local memory. If the maximum number of allocatable objects its_max_no_alloc, is not attained, the service aligns the size of the new object on a word boundary, i.e. it allocates an object with a size that is a real multiple of the size of a word, the real size corresponding to the first multiple that is greater than the size of the object to be allocated. The service reads the size of the available memory in the memory descriptor. This size is referenced in the fields its_size, and the address of the free memory zone is referenced its_ptr, which indicates the current position in the available memory heap. If sufficient memory remains in the heap, the service adds the new MM_OBJECT type allocated object to the table 1 of the objects, its_table.

The descriptor MM_OBJECT associated with an allocated memory object comprises the following fields:

the address of the allocated object in the memory, its_address;

the size of the object in bytes, its_size;

the name of the calling file, its_file;

the number of the allocation line in the file, its_line.

The new object is stacked in the objects table which behaves like a LIFO (“Last In First Out”) file where the last object recorded in the table will be the first object to be erased. The service increments the current number of the allocated objects, its_no_objects by one unit. The service decrements the size of the available memory its_size, and increments the address of the free memory zone, its_ptr, by the size of the new object. The service sends on the pointer its_ptr which indicates the new current position in the available memory heap.

The service can allocate an object in shared mode. It then stores the address and its label, or name, in an object known as an MM_SH_OBJECT type shared object arranged in the table 2 of the shared objects, its_shared_tab. The descriptor MM_SH_OBJECT has the following fields:

the name of the shared object, its_label

the address of the shared object, its_address;

and the indicator of access to the object, its_init_flag.

If the name of the new shared object is not already in the table of the shared objects and if the maximum number of objects allocatable in shared mode its_max_no_shared_alloc, is not reached, then the service stacks the new shared object in the table of shared objects which then also behaves like a LIFO stack. The service increments the current number of shared objects its_no_shared_objects by one unit. Any allocated object, whether shared or not, is added to the table of objects. The table of shared objects complements the table of objects. At the user's request, the service may preset the allocated object at zero. When a condition is not met, the service MM_alloc( ) activates an error message by which it is possible to check the operation of the memory in the application.

The service aligns the size of a new object on a word boundary. With an address of the free memory zone, its_ptr, initially placed on a word boundary, the service MM_alloc( ) keeps the alignment of the objects on a word boundary.

The dynamic memory release service MM_free( ) is used to release an object, previously allocated by the dynamic memory allocation service MM_alloc( ), from the local memory. The service MM_free( ) verifies the equality between the address of the object to be released that has been passed into the form of a parameter and the address of the last object of the table, its_table, of the allocated objects. The service thus ascertains that the object whose release is requested is truly the last one allocated object. The service manages the objects table in the form of a stack. The service then examines the equality between the address of the object to be released and the address of the last object of the stack of the shared objects. If the equality is not verified, the object to be released is not an object in shared mode, and the service releases the object from the objects table its_table. If equality is verified, the object is in shared mode and, for each remote elementary computer, the service MM_free( ) verifies that the object to be released is absent from the list, reserved for this computer, of the attached objects. Then the service releases the object from the objects table, its_table and from the shared mode objects table, its_shared_tab. Finally, the service updates the information on the availability of the memory in incrementing the size of the available memory, its_size by the size of the released object and decrementing the current pointer in the memory its_ptr by the same value.

The procedure carries out dynamic allocations and dynamic releases of memory in a specified order so that the first released object corresponds to the last allocated object. The method manages all the allocated objects as a stack. The memory management method has the advantage of not fragmenting the memory. It is used to ascertain that a release has not been overlooked.

The service MM_free( ) sees to the destruction of an object exclusively by its proprietor computer and it conditionally ties the release of the memory zone assigned to this object to the absence of the attachment of a remote computer to the object. The service has the advantage of having a blocking role when there remain attachments to the object to be released. The method thus controls the dependencies of attachment of objects allocated in shared mode.

The method has a service MM_avail_size( ) by which it is possible to know the size of the memory still available for an object allocation. The service sends on the value of the field its_size of the memory manager.

In addition to the dynamic allocation and dynamic memory release, the method proposes a mechanism of access to a shared object by a remote elementary computer especially by means of dedicated services. These are visibility-providing MM_shared_enable( ), attachment MM_attach( ) and detachment MM_unattach( ) services relying on the memory manager.

The method includes a service for making visible an object, MM_shared_enable( ), authorizing access to an object previously allocated in shared mode. During the allocation in the local memory of the proprietor elementary computer, the object allocated in shared mode is not accessible to the other computers. The service MM_shared_enable( ) of the proprietary computer of the object makes a search by name for the object to be made accessible in the table of the shared objects, its_shared_table, then it positions the access indicator, its_init_flag, of the object found to authorize access to this object by remote elementary computers. The method declares this object to be visible to the remote computers. The method has an optional declaration controlled by the proprietary computer for making visible an allocated object in shared mode. The objects not allocated in shared mode remain invisible to a remote computer.

The mechanism providing access to a shared object comprise general mechanisms for accessing the memory of the remote computers and mechanisms of search and attachment to an object belonging to a remote elementary computer.

In the method, the access to the memory of the remote computer is obtained by access to the memory manager of said remote computer in two steps. In a first step, in a phase of initialization of the service, MM_init( ), the descriptors MM_MEM of the remote computers, which are launched in parallel, are referenced in the local descriptor, in the table its_proc_mem. The referencing depends on the machine considered. For example in FIG. 2, this table 8 contains the addresses of the managers of the remote computers. More specifically, the processing machine considered in the invention is used to create shared memory tables, i.e. each elementary computer is capable of accessing the memory of another elementary computer in read mode and in write mode, simply by reading or writing in the memory zone known as a mapped zone. The machine considered may have a centralized shared-memory architecture, such as for example a CRAY machine where the internal memory is common to all the elementary computers. However, it may also have a distributed-memory architecture, for example a MERCURY COMPUTER SYSTEMS memory or an SGI machine where the local memories of the elementary computers are different but where an elementary computer can access a memory zone of another elementary computer inasmuch as the zone has been initialized in the form of a shared table. Thus, in the first type of machine, which is a centralized shared-memory machine, the service places the remote computers referred to in the table its_proc_mem by storing therein the addresses of the memory managers of the other computers. In the second type of machine, namely the local memory machine, the service creates an access handle to the remote memory by calling upon dedicated services of the system management. An access handle is a pointer's pointer.

In the second step of access to the memory manager of the remote computer, the method carries out a mapping of the reference of a remote computer with a virtual address, this address being used for the physical reading and writing in the memory of the remote computer. In the first type of centralized memory machine, the mapping is immediate in the first phase, the reference being equal to the address of the object. In the second type of local memory machine, the method carries out the mapping by means of calls to functions of the operating system of the machine. It must be noted that the mapping on an SGI machine is automatically managed by the operating system of the machine and, seen from the user, it is more closely related to the general memory model of the CRAY machine. With the virtual address, the method enables the elementary computer to access the manager of the remote computer. The mapping places the elementary computer and the remote computer in a state of inter-visibility.

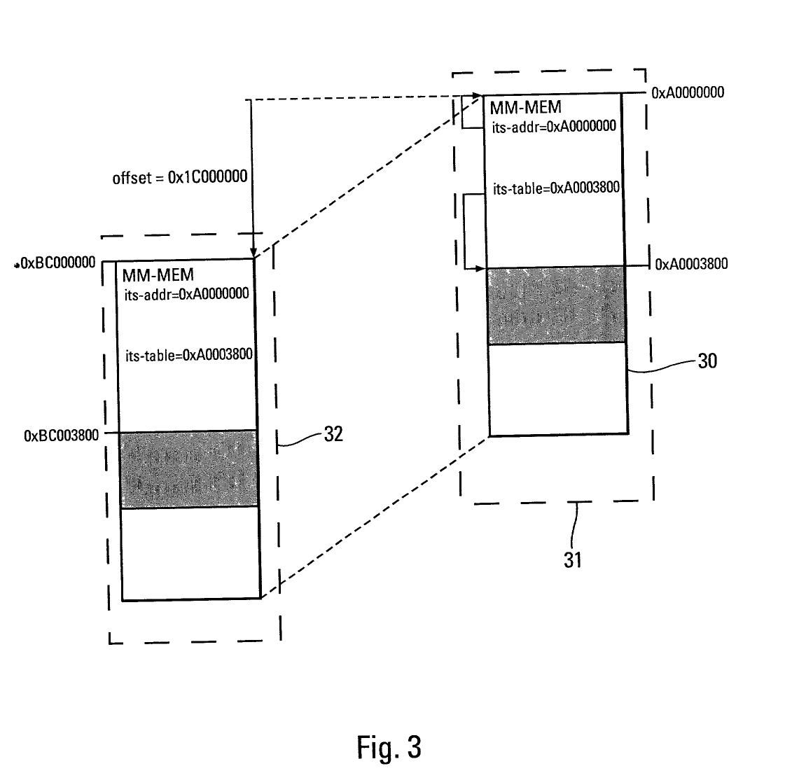

In the example shown in FIG. 3, a computer 31 presents a memory manager whose descriptor 30 is located at the address 0xA0000000. In the method, all the addresses contained in the descriptor relate to the addressing space of the computer that is the proprietor of the manager, for example the pointer its_table points at the objects table 0xA0003800 and the pointer its_addr effectively points at the start of the descriptor 0xA0000000. In the memory of a second computer 32, called a local computer, the method maps the remote descriptor 30 at the virtual address 0xBC000000 and the local computer 32 then reads the fields of the remote descriptor 30. In the example its_table contains 0xA0003800 and its_addr contains 0xA0000000. This accessible information cannot be immediately used by the local computer 32. This is why the method carries out a conversion of the values read by adding the offset between the two addressing operations, namely the difference between 0xBC000000 and 0xA0000000, equal to 0x1C000000. The converted values are thus expressed in the addressing space of the local computer 32 and can be directly used by this computer.

The method converts the remote addresses contained in the remote manager into local addresses that can be exploited by the local computer by adding an offset thereto. The offset is equal to the shift between the virtual address of the remote descriptor 30 in the descriptor of the local computer 32 and the contents of the remote address of the start of the remote descriptor 30. The method converts the access addresses to the tables used to manipulate the remote descriptor and the addresses of the allocated objects contained in said descriptor.

The method proposes a service MM_attach( ) for the attachment of a local computer to a remote object. The attachment service makes a search, by name, for the object on the remote computer or, in one variant, on a single remote computer whose number is designated. To this end, it carries out a mapping of the remote descriptor from its reference stored in the table of the addresses of the managers, its_proc_mem, which gives a virtual address providing access to the memory manager of the remote computer; it searches for the object in the remote table of the shared objects, its_shared_tab, in making a search for an input in this table whose name corresponds to the name being searched for and whose access indicator is positioned; if the object is not found, or if the number of attachable objects of the remote computer, its_max_no_attach_obj, is reached, the mapping of the remote descriptor is eliminated; else the mapping of the remote computer is maintained throughout the period when the attachment is maintained, the field of the number of mapped computers, its_no_map_proc, of the local computer is incremented and the service converts the remote address of the object, saved at the input found, into a local address by addition of an offset. When the attachment service is called with the designation of the number of the remote computer possessing the object to be attached, the method consists of a verification, in the table 7 shown in FIG. 2, of logic numbers associated with the mapped computers, its_map_proc_id, if this computer is already mapped. If this is not the case, it maps it and adds it to the end of the table designated by its_map_proc_id. This approach is far more efficient in execution time than the search by name of the object for it avoids the need to go through all the remote computers. However, it makes it necessary to store the name of the computer possessing the object.

The service then makes a declaration of attachment to the found object in the remote memory descriptor. For this purpose, each memory manager contains one information zone, 4, 5 or 6 in FIG. 2, per elementary computer. This is a zone of the MM_ATTACH type in the form of a table of objects belonging to this manager and attached to this remote computer.

The descriptor MM_ATTACH comprises the following fields:

the number of objects attached to this elementary computer its_no_objects;

the table of the addresses of the objects attached by this elementary computer its_objects.

The service MM_attach( ) increments the number of attached objects its_no_objects in the manager of the remote computer and stores the address of the new attached object in the corresponding table its_objects. The attachment service works in run mode: the search for the objects and the attachment if any are done once and the service ends whether the attachment has been successful or not. In one variant, the service works in inhibit mode: the method does not go out of the service so long as the object being searched for has not been found and there is no time lag. The attachment in run mode is useful for reconfiguration services when, for example, one computer is replaced by another. The new environment may be created without synchronization since it is only a substitution of a computer with invariant objects. The variant in inhibit mode is more commonly used because it ensures that the attached objects are truly created. This variant is used in the initialization of the memory managers, enabling an implicit synchronization of all the computers forming the processing machine.

The structure according to which the attachments are declared constitutes a stack in which each attached object is added and each detached object is removed. The information saved for an attached object is its address. Several attachments to one and the same object can made by the same elementary computer. The stack can therefore contain the same address several times, not necessarily in a contiguous way.

In a memory manager, all the zones MM_ATTACH for all the remote computers are grouped together in a table 3 pointed at by its_attach_tab which contains as many inputs 4, 5, 6 as there are elementary computers executing the program. The input (i) of the table corresponds to the attachments of the computer number (i). Each zone MM_ATTACH of a local manager is dedicated to a remote computer, the write access being reserved for this remote computer. The method has the advantage of avoiding conflicts of access of the standard method in the implementation of the management of UNIX type files consisting of the management of a reference counter.

The declaration of attachment informs the proprietor of the object that a remote elementary computer has attached itself to this object. When the proprietor elementary computer wishes to destroy an object, it consults the attachment stack of each remote elementary computer, and makes a search in each stack for the input or inputs containing the address of the object to be destroyed. The destruction or release is done by the service MM_free( ) only when the object is not declared to be attached in any of the attachment stacks. The declaration of attachment enables the method to prevent the destruction of the object so long as the attachments are kept.

The method proposes a service MM_unattach( ) to detach a local computer from a remote object. The attachment service carries out a search, by name of the object of detachment, of the local computer to be detached. This search is made on each locally mapped remote computer, the number of these computers being equal to the field of the number of mapped computers, its_no_map_proc, of the local computer to be detached; in one variant, the service carries out the search on a single remote computer whose number is designated. The service searches for the object in the remote table of the shared objects its_shared_tab in searching for an input in this table whose name corresponds to the name of being sought. The service verifies, in the remote manager, that the last element of the stack of attachments of the local computer j arranged in its_attach_tab(j) corresponds to the object to be detached. The service thus makes it possible to ascertain that the object whose detachment from the local computer is requested is truly the last object of the remote computer to which the local computer had attached itself.. The method manages the stack of the attachments in LIFO mode. Finally, the service unstacks the object from the attachment stack of the remote descriptor, and then it eliminates the mapping of this remote descriptor.

The method can be used to access memory objects of remote elementary computers.

The method comprises a transfer mechanism between a local memory object and a remote memory object. This mechanism is implemented by means of three dedicated services: an initialization of a MM_transfer init( ), a performance of the transfer MM_transfer( ) and the destruction of the initialized transfer MM_transfer disp( ).

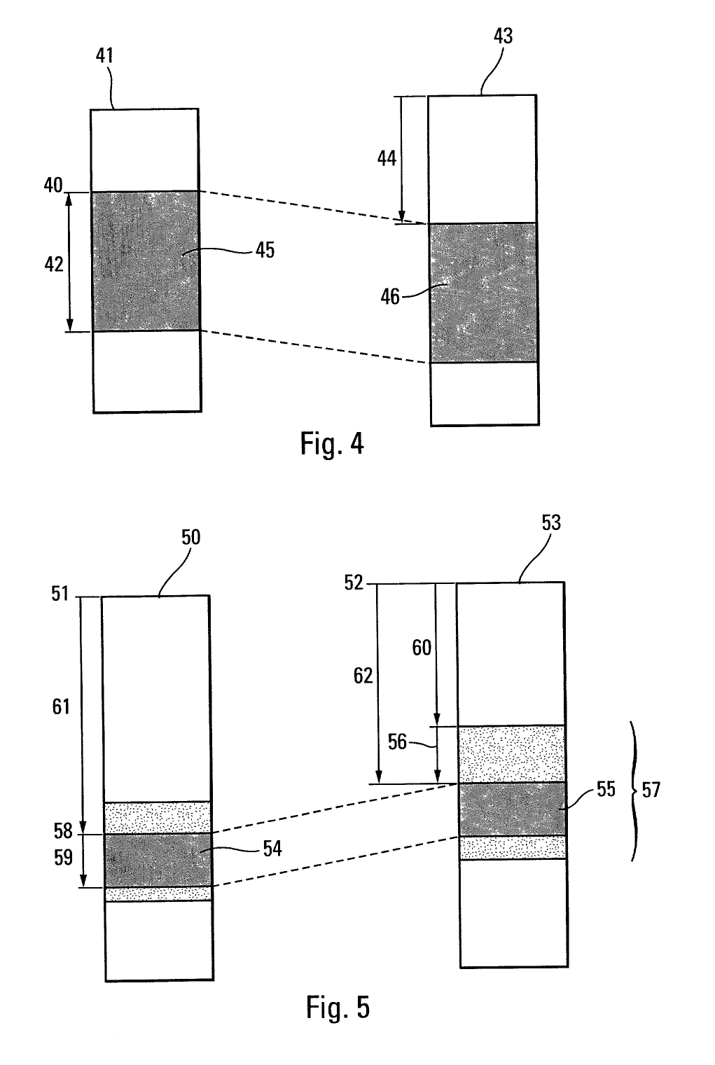

FIG. 4 illustrates the transfer of data between a local memory object 41 called a source and a remote memory object 43 called an addressee or target. A first memory zone 45 of the source is transferred into a second memory zone 46 of the addressee. The first memory zone 45 presents an address 40 in the source 41 and a size 42. The second memory zone 46 has a position 44 in the addressee.

The initialization of the transfer consists of the definition of the source local memory object, the addressee remote memory object and the characteristics of the transfer. The initialization consists in setting up a link between the two memory zones concerned. This link corresponds to the physical initialization, which is for example a DMA (direct memory access) type of initialization, enabling subsequent effective transfers.

The initialization service of a transfer MM_transfer_init( ), carries out the initialization on the basis of the following transfer parameters represented in FIG. 4:

the address 40 of the zone to be transferred into the source local object, ptr_src;

the size 42 of the data to be transferred, size;

the name of the remote addressee object 43, for example [symbol] rem_obj [symbol] ;

and the position 44 of the transferred zone in the addressee object, usr_offset.

The service checks the parameters and allocates a descriptor MM_TRANSFER that stores the information and the allocated resources during the initialization the descriptor MM_TRANSFER comprises the following fields:

the information on the source its_src;

the information on the addressee: its_dst;

the information on the system to perform the transfer: its_sys_info.

The service carries out an attachment of the remote object by its name. The entire remote memory descriptor is mapped locally and the service gives a local address of the remote object. Depending on the processing machine considered, the service implements a physical initialization of the transfer. Then it eliminates the mapping from the remote memory descriptor while maintaining the attachment reference updated in the remote descriptor during the attachment. The service thus makes it possible to prevent the destruction of the remote addressee object of a transfer. The service sends on the address of the transfer descriptor.

On a CRAY type centralized-memory machine, the physical initialization of the transfer is unnecessary. On a local memory machine, for example a MERCURY COMPUTER SYSTEMS type of machine, a memory transfer between computers is done not on the memory object but on the memory descriptors of the elementary computers concerned. In this case, illustrated in FIG. 5, the MM_transfer_init( ), initializing a transfer between a source zone 54 and addressee zone 55, retrieves the access handle 51 of the local source descriptor 50 of the transfer and the handle 52 of the remote addressee descriptor 53 of the transfer. Then, it converts the transfer parameters, since the origin of the transfer is no longer at the start of the memory objects but at the start 51 and 52 of the memory descriptors, and makes calls, for dx_create( ), dx_copy( ), to the system of the machine applying to the access handles. The new parameters for these system calls are the position 61 of the source zone 51 in the source descriptor 50, the position 62 of the addressee zone 55 in the addressee descriptor 53 and the size 59 of the data to be transferred. The service computes these new parameters on the basis of the initial transfer parameters: the offset 56 in the remote addressee object 57, usr offset; the address 58 of the local source buffer ptrc; the size 59 of the transfer, size; and prepared information such as the position 60 of the remote object with respect of the start of the memory descriptor, obj_offset. This initialization service of a transfer is used to group together processing operations specific to the processing machine considered.

The transfer service, MM_transfer( ), carries out the transfer of memory between two remote objects. In the first type of centralized shared-memory machine, the transfer is a simple copy. In the second type of real-time local memory machine of the MERCURY COMPUTER SYSTEMS type, the transfer uses DMAs by using services of the system of the machine, for example dx_start( ).

The service MM_transfer disp( ) carries out the destruction of a transfer. The transfer destruction service releases the system resources implemented during the physical initialization of the transfer according to the machine considered. Thus, on a MERCURY COMPUTER SYSTEMS system, the allocated resources are destroyed by calling on the services of the system, for example dx_release( ), dx_destroy( ). The service for the destruction of a transfer maps the remote elementary computer that is a proprietor of the addressee object of the transfer and obtains a local address of the remote descriptor. The service gets detached from the remote objects. Then, it releases the transfer descriptor.

Through the transfer from memory to memory, the method is used to read or write a remote object allocated in shared mode. The method has the advantage of preventing the systematic mapping of the remote memory object for the writing or reading therein of data. It provides a gain in performance. The duration of the mapping is limited to the duration of the attachment to the addressee object which is prior to the initialization of the transfer. Since the mapping is destroyed during the initialization of the transfer, it is not maintained throughout the duration of the transfer.

The method can be used to carry out a memory transfer in parallel with other activities in the elementary computer, should this be compatible with the processing machine. The method can be used to manage synchronous and asynchronous transfers. With an asynchronous transfer, the time taken by inputs and outputs is masked, for example by the time taken for computation on other data. The invention can be used for the parallel performance of memory transfers on several remote elementary computers.

Finally, the method has a service MM_disp( ) for the destruction of the memory manager. The service MM_disp( ) releases the memory from the elementary computer by an appeal to the operating system of the machine when this memory no longer contains any attachment of the remote computer nor any allocated objects.

The method performs only one allocation by the operating system of the processing machine and only one release of the memory of the elementary computer at the instantiation and destruction of the memory management entity. The available memory is allocated only once and all the entities instantiated thereafter are instantiated from this initial quantity of memory. The method is used to limit the number of calls on the operating system of the processing machine. The method is used to provide for a dynamic allocation and a dynamic release of the objects in memory in a way that is more efficient than the primitives of the operating system of the machine.

What is claimed is:

1. A method for the management of the memory of a machine comprising several elementary computers each having a local memory, wherein the method comprises the following services:
an allocation of an initial quantity of memory in the local memory of at least one elementary computer;
a dynamic allocation and a dynamic release of objects by the elementary computer in its initial quantity of memory, such that the first released object is the last allocated object;
a dynamic allocation, by an elementary computer in its initial quantity of memory, of a shared object such that said elementary computer is the proprietor of the shared object and declares this shared object to be accessible to one or more remote elementary computers;
an attachment of at least one remote elementary computer to the shared object, said remote elementary computer not being a proprietor of the shared object, with a list of attachments managed by the elementary computer that is the proprietor of the shared object;
a detachment of a remote elementary computer from the shared object with the updating of said list of attachments;
a transfer from an object of an elementary computer to a shared object of a remote elementary computer;
a release of the local memory for each elementary computer.

2. A memory management method according to claim 1, comprising a memory manager through which the method carries out said services

3. A memory management method according to one of the claims 1 and 2 wherein, during the allocation of said initial quantity of memory in the local memory of an elementary computer, a memory manager is instantiated in said allocated quantity of memory.

4. A memory management method according to claim 2, wherein a single allocation of memory of said elementary computer is made during the instantiation of said memory manager.

5. A memory management method according to one of the claims 3 to 4, wherein a single release of memory of said elementary computer is carried out during the destruction of said memory manager.

6. A memory management method according to one of the claims 3 to 5, wherein one and the same memory manager is instantiated on the different elementary computers.

7. A memory management method according to one of the claims 3 to 6, wherein said list of attachments belongs to the memory manager of the proprietor computer of the object that is shared and attached.

8. A memory management method according to claim 7, wherein said memory manager of the proprietor computer comprises one zone per remote computer, each zone being reserved for a single remote computer in which said method stores the attachments of said remote computer on the object of the proprietory computer.

9. A memory management method according to claim 8, wherein said attachments are stored by elementary computer so that the first detached object is the last attached object.

10. A memory management method according to claim 8, wherein an object allocated in shared mode is destroyed only by the proprietary elementary computer and when said object no longer has any attachment.

11. A memory management method according to one of the above claims wherein, during the attachment of an elementary computer to a remote object, the remote addresses of the attached object are automatically converted into local addresses of said elementary computer.

12. A memory management method according to one of the above claims, wherein a transfer is made without maintaining the mapping of the distant memory manager.

13. A memory management method according to one of the above claims, wherein parallel transfers are carried out on several remote computers.

14. A memory management method according to one of the above claims, wherein a transfer and other activities are carried out in parallel in the elementary computer.

15. A memory management library implementing the method according to one of the above claims.

16. A processing machine comprising several elementary computers, implementing the method according to one of the above claims.
